(19) United States
(12) Patent Application Publication
(10) Pub. No.: US 2026/0002604 A1
(43) Pub. Date: Jan. 1, 2026

(54) REVERSING VALVE AND THERMAL MANAGEMENT SYSTEM

(71) Applicant: Schaeffler Technologies AG & Co. KG, Herzogenaurach (DE)

(72) Inventors: Yinxian Tao, Shanghai (CN); Chen Wang, Shanghai (CN); Tian Tang, Shanghai (CN)

(73) Assignee: Schaeffler Technologies AG & Co. KG, Herzogenaurach (DE)

(21) Appl. No.: 19/251,799

(22) Filed: Jun. 27, 2025

(30) Foreign Application Priority Data
Jul. 1, 2024 (CN) 202410875926.9

(51) Int. Cl. F16K 31/06; F16K 1/42

(52) U.S. Cl. CPC F16K 31/0627; F16K 1/42; F16K 31/0675

(57) ABSTRACT

A reversing valve and a thermal management system are provided. The reversing valve includes a valve body, a first valve seat, a second valve seat, and a first valve core. The valve body includes a valve cavity and a mounting end in communication with the valve cavity. The first valve seat and the second valve seat are arranged opposite one another within the valve cavity. The first valve core is movably disposed between the first valve seat and the second valve seat and is configured to be separated from one of the first valve seat and the second valve seat when abutting against the other of the first valve seat and the second valve seat. The first valve seat, the second valve seat, and the first valve core are configured to be inserted into the valve cavity via the same mounting end.

### CROSS-REFERENCE TO RELATED APPLICATIONS

This application claims priority under 35 U.S.C. Section 119 of Chinese Patent Application Serial No. 202410875926.9 filed on Jul. 1, 2024, the entire disclosure of which is incorporated herein by reference.

### TECHNICAL FIELD

The present application relates to the field of valves, and more particularly to a reversing valve and a thermal management system.

### BACKGROUND

Chinese patent application CN115978227A discloses a pilot-operated two-position four-way solenoid valve. When a coil is in an unpowered state, a first seal abuts against an end cover and a second seal abuts against a main body of a valve body, so that fluid at a port P flows to a port A, and a port B is in mutual communication with a port E. When the coil is in a powered state, the first seal abuts against the main body of the valve body and the second seal abuts against a piston seat, so that the fluid at the port P flows to the port B, and the port A is in mutual communication with the port E.

However, when the above-mentioned solenoid valve is assembled, the first seal and the end cover are required to be inserted into the main body of the valve body from one side of the main body of the valve body, and the second seal and the piston seat are required to be inserted into the main body of the valve body from the other side of the main body of the valve body. This makes the assembly and disassembly of the solenoid valve more complicated, which is disadvantageous for the use of the solenoid valve in highly integrated scenarios.

### SUMMARY

The present application is provided in view of the state of the prior art as described above. It is an objective of the present application to provide a reversing valve and a thermal management system that can overcome or mitigate at least one of the drawbacks described in the above-mentioned background art.

To achieve the above-mentioned objective, the present application adopts the following technical solutions.

The present application provides a reversing valve, comprising: a valve body comprising a valve cavity and a mounting end in communication with the valve cavity; a first valve seat and a second valve seat, the first valve seat and the second valve seat being arranged opposite one another within the valve cavity; and a first valve core, the first valve core being movably disposed between the first valve seat and the second valve seat and configured to be separated from one of the first valve seat and the second valve seat when abutting against the other of the first valve seat and the second valve seat, wherein the first valve seat, the second valve seat, and the first valve core are configured to be inserted into the valve cavity via the same mounting end.

In an alternative solution, the reversing valve further comprises: a third valve seat, the third valve seat and the first valve seat being arranged facing away from each other within the valve cavity; and a second valve core, the second valve core being fixedly connected to the first valve core within the valve cavity, wherein the second valve core is configured to be separated from the third valve seat when the first valve core abuts against the first valve seat, and the second valve core is configured to abut against the third valve seat when the first valve core abuts against the second valve seat.

In another alternative solution, the reversing valve further comprises a fourth valve seat, the third valve seat and the fourth valve seat are arranged opposite one another within the valve cavity, the second valve core is movably disposed between the third valve seat and the fourth valve seat and configured to be separated from one of the third valve seat and the fourth valve seat when abutting against the other of the third valve seat and the fourth valve seat, and the second valve core is configured to abut against the fourth valve seat when the first valve core abuts against the first valve seat.

In another alternative solution, at least a portion of the first valve seat and at least a portion of the third valve seat are integrally formed.

In another alternative solution, the reversing valve further comprises a pilot valve for adjusting a position of the first valve core, the pilot valve comprising a pilot valve core arranged coaxially with the first valve core.

In another alternative solution, the first valve seat is constructed by a first valve sleeve, and the second valve seat is constructed by a second valve sleeve independent of the first valve sleeve.

In another alternative solution, the first valve sleeve and the second valve sleeve are cylindrical, wherein the first valve sleeve is provided with one or more first passages extending through a circumferential wall of the first valve sleeve along a radial direction of the first valve sleeve, the second valve sleeve is provided with one or more second passages extending through a circumferential wall of the second valve sleeve along a radial direction of the second valve sleeve, and the first passage is configured to be in communication with the second passage when the first valve core abuts against the second valve seat.

In another alternative solution, the reversing valve further comprises a valve stem disposed on a radially inner side of the first valve sleeve and supporting the first valve core, the valve stem and the first valve seat jointly define a third passage, and the first passage is configured to be in communication with the second passage via the third passage when the first valve core abuts against the second valve seat.

The present application also provides a thermal management system, comprising: a distributor, which comprises a plurality of interfaces and a distribution passage connected between the plurality of interfaces; and a reversing valve according to any of the above-mentioned technical solutions, the reversing valve being connected to the distribution passage via the interfaces.

In an alternative solution, at least a portion of the valve body is integrally formed with at least a portion of the distributor.

By adopting the above-mentioned technical solutions, through providing the first valve seat and the second valve seat arranged opposite one another, and having the first valve seat, the second valve seat, and the first valve core inserted into the valve cavity via the same mounting end, the first valve seat, the second valve seat, and the first valve core can be easily installed onto the valve body and separated from the valve body, thereby making the reversing valve easy to assemble and disassemble.

### BRIEF DESCRIPTION OF THE DRAWINGS

FIG. 1 is a cross-sectional view of a reversing valve according to a first embodiment of the present application, in which the reversing valve is in a first mode.

FIG. 2 is a cross-sectional view of the reversing valve in FIG. 1, in which the reversing valve is in the first mode.

FIG. 3 is a schematic diagram of an end piece of the reversing valve in FIG. 1.

FIG. 4 is a cross-sectional view of the reversing valve in FIG. 1, in which the reversing valve is in a second mode.

FIG. 5 is a cross-sectional view of a reversing valve according to a second embodiment of the present application, in which the reversing valve is in a first mode.

FIG. 6 is a cross-sectional view of the reversing valve in FIG. 5, in which the reversing valve is in the first mode.

FIG. 7 is a cross-sectional view of the reversing valve in FIG. 5, in which the reversing valve is in a second mode.

FIG. 8 is a cross-sectional view of the reversing valve in FIG. 5, in which the reversing valve is in a second mode.

### DETAILED DESCRIPTION

Exemplary embodiments of the present application are described in the following with reference to the drawings. It is to be understood that these specific descriptions are only used to teach those skilled in the art how to implement the present application, and are neither intended to be exhaustive of all possible implementations of the present application nor to limit the scope of the present application.

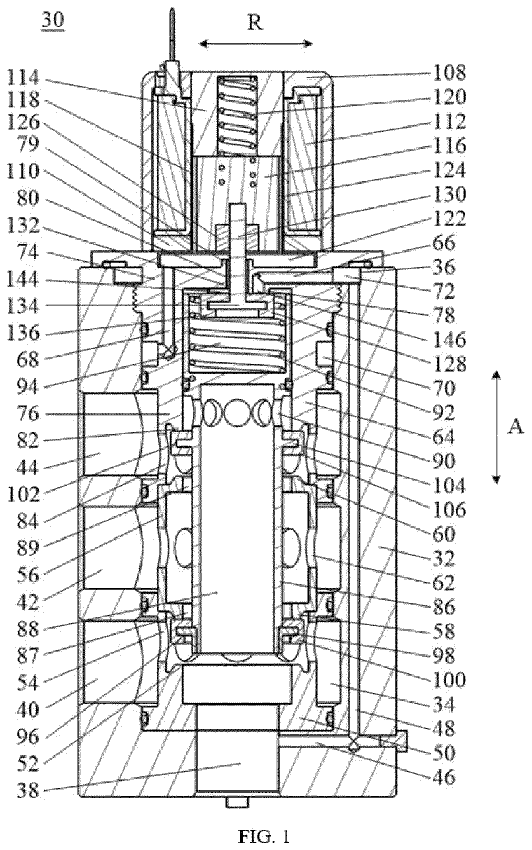

The structure of the reversing valve according to the first embodiment of the present application will be described below with reference to FIGS. 1 to 4.

FIG. 1 is a cross-sectional view of a reversing valve 30.

The reversing valve 30 may comprise a columnar valve body 32.

The valve body 32 may comprise a valve cavity 34 and a mounting end 36. The valve cavity 34 may be a columnar space and is arranged coaxially with the valve body 32. The mounting end 36 may be disposed at an upper end of the valve body 32 and in communication with the valve cavity 34.

The valve body 32 may further comprise medium ends 38, 40, 42, 44. The medium end 38 may be disposed at a lower end of the valve body 32 and extend along an axial direction A of the valve body 32. The medium ends 40, 42, 44 may be disposed at an outer circumferential portion of the valve body 32 and extend along a radial direction R of the valve body 32. The medium end 38 may be arranged coaxially with the valve cavity 34, and the medium ends 40, 42, 44 may be arranged side-by-side along the axial direction A.

The valve body 32 may further comprise a passage 46 and a passage 48. The passage 46 may be disposed on a lower side of the valve cavity 34 and extend along the radial direction R. The passage 48 may be disposed on a radially outer side of the valve cavity 34 and extend along the axial direction A.

The reversing valve 30 may further comprise a cylindrical valve sleeve 50 (an example of the second valve sleeve). The valve sleeve 50 may be inserted into the valve cavity 34 via the mounting end 36 and arranged coaxially with the valve body 32. The valve sleeve 50 may comprise a valve seat 52 (an example of the second valve seat) and a plurality of passages 54 (an example of the second passage). The valve seat 52 may be disposed at an inner circumferential portion of the valve sleeve 50 and extend circumferentially along the entire circumference. The passage 54 may extend through a circumferential wall of the valve sleeve 50 along the radial direction R, and the plurality of passages 54 may be arranged side-by-side in the circumferential direction.

The reversing valve 30 may further comprise a cylindrical valve sleeve 56 (an example of the first valve sleeve). The valve sleeve 56 may be inserted into the valve cavity 34 via the mounting end 36 and arranged coaxially with the valve body 32. A lower end of the valve sleeve 56 may abut against an upper end of the valve sleeve 50. The valve sleeve 56 may comprise a valve seat 58 (an example of the first valve seat), a valve seat 60 (an example of the third valve seat), and a passage 62 (an example of the first passage). The valve seats 58, 60 may be integrally formed and arranged opposite to each other along the axial direction A. The valve seat 58 may be disposed at the lower end of the valve sleeve 56 and extend circumferentially along the entire circumference. The valve seat 52 and the valve seat 58 may be arranged opposite one another along the axial direction A, and the passage 54 may be disposed between the valve seat 52 and the valve seat 58. The valve seat 60 may be disposed at an upper end of the valve sleeve 56 and extend circumferentially along the entire circumference. The passage 62 may extend through the circumferential wall of the valve sleeve 56 along the radial direction R, and a plurality of passages 62 may be arranged side-by-side in the circumferential direction.

The reversing valve 30 may further comprise an end piece 64. The end piece 64 may be inserted into the valve cavity 34 via the mounting end 36 and arranged coaxially with the valve body 32. The end piece 64 may comprise passages 66, 68. The passage 66 may extend along the radial direction R, and the passage 68 may extend along the axial direction A. The end piece 64 and the valve body 32 may jointly define passages 70, 72, and the passages 70, 72 may extend circumferentially along the entire circumference. The end piece 64 may be threadedly engaged with the valve body 32 so as to retain the valve sleeves 50, 56 within the valve cavity 34. Here, the valve sleeves 50, 56 and the end piece 64 may be individual parts independent of each other.

The end piece 64 may further comprise a valve cover 74 and a cylindrical valve sleeve 76. The valve cover 74 may cover the mounting end 36. An upper end of the valve sleeve 76 may be integrally formed with and joined to a lower end of the valve cover 74, and a lower end of the valve sleeve 76 may abut against the upper end of the valve sleeve 56. The valve cover 74 may comprise valve seats 78, 79 and a through-hole 80. The valve seat 78 may protrude downwards from the lower end of the valve cover 74 and be located on a radially inner side of the end piece 64. The valve seat 79 may protrude upwards from the upper end of the valve cover 74 and extend circumferentially along the entire circumference. The through-hole 80 may extend through the valve cover 74 along the axial direction A and be arranged coaxially with the valve cavity 34. The valve sleeve 76 may comprise a valve seat 82 (an example of the fourth valve seat) and a plurality of passages 84. The valve seat 82 may be disposed at an inner circumferential portion of the valve sleeve 76 and extend circumferentially along the entire circumference. The passage 84 may extend through a circumferential wall of the valve sleeve 76 along the radial direction R, and the plurality of passages 84 may be arranged side-by-side in the circumferential direction. The valve seat 60 and the valve seat 82 may be arranged opposite one another along the axial direction A, and the passage 84 may be disposed between the valve seat 60 and the valve seat 82.

The reversing valve 30 may further comprise a valve stem 86. The valve stem 86 may be inserted into the valve cavity 34 via the mounting end 36 and arranged coaxially with the valve body 32. The valve sleeves 56, 76 and the end piece 64 may be sleeved onto the valve stem 86, and the valve stem 86 may move along the axial direction A under the guidance of the end piece 64. The valve stem 86 may comprise an inner cavity 88 and a plurality of passages 90. The inner cavity 88 may be in communication with the outside of the valve stem 86 via a lower end of the valve stem 86. The passage 90 may extend through a circumferential wall of the inner cavity 88 along the radial direction R, and the plurality of passages 90 may be arranged side-by-side along the circumferential direction. The valve stem 86 may extend through the valve sleeve 56. An annular space between an outer circumferential surface of the valve stem 86 and an inner circumferential surface of the valve seat 58 may be formed as a passage 87 (an example of the third passage), and an annular space between the outer circumferential surface of the valve stem 86 and an inner circumferential surface of the valve seat 60 may be formed as a passage 89.

The reversing valve 30 may further comprise a spring 92. The end piece 64 and the valve stem 86 may jointly define a cavity 94. The cavity 94 may be disposed between the valve cover 74 and the valve stem 86, and the spring 92 may be disposed within the cavity 94. The spring 92 may be arranged coaxially with the valve stem 86 and configured to bias the valve stem 86 downwardly.

The reversing valve 30 may further comprise an annular valve core 96. The valve core 96 may be arranged coaxially with the valve stem 86 and fixedly supported onto the valve stem 86. The valve core 96 may be disposed between the valve seat 52 and the valve seat 58. When the valve core 96 abuts against the valve seat 52, the valve core 96 may be separated from the valve seat 58 and form a scaling pair with the valve seat 52. When the valve core 96 abuts against the valve seat 58, the valve core 96 may be separated from the valve seat 52 and form a sealing pair with the valve seat 58. The valve core 96 may comprise a frame 98 and a seal 100. The frame 98 may be fixedly sleeved onto the valve stem 86. The seal 100 may be supported onto the frame 98 for making contact with the valve seats 52, 58.

As an example, the valve sleeve 56 and the valve core 96 may be pre-sleeved onto the valve stem 86 before insertion into the valve cavity 34 so that the valve sleeve 56 is retained between the valve core 96 and a valve core 102. The valve sleeves 50, 56 may then be inserted into the valve cavity 34 integrally or separately.

The reversing valve 30 may further comprise an annular valve core 102 (an example of the second valve core). The valve core 102 may be arranged coaxially with the valve stem 86 and fixedly supported onto the valve stem 86. The valve core 102 may be disposed between the valve seat 60 and the valve seat 82. When the valve core 102 abuts against the valve seat 60, the valve core 102 may be separated from the valve seat 82 and form a sealing pair with the valve seat 60. When the valve core 102 abuts against the valve seat 82, the valve core 102 may be separated from the valve seat 60 and form a sealing pair with the valve seat 82. The valve core 102 may comprise a frame 104 and a seal 106. The frame 104 may be integrally formed with the valve stem 86 and protrudes from the outer circumferential surface of the valve stem 86 to the radially outer side. The seal 106 may be supported onto the frame 104 for making contact with the valve seats 60, 82.

It will be appreciated that by providing oppositely arranged valve seats 52, 58 and oppositely arranged valve seats 60, 82, and having the valve seats 52, 58, 60, 62 and valve cores 96, 102 inserted into the valve cavity 34 via the same mounting end 36, the valve seats 52, 58, 60, 62 and valve cores 96, 102 can be easily mounted onto the valve body 32 and separated from the valve body 32, thereby making the reversing valve 30 easy to assemble and disassemble.

The reversing valve 30 may further comprise a cylindrical valve body 108 and an annular end cover 110. The valve body 108 and the end cover 110 may be made of soft magnetic material, and the end cover 110 may be capped onto a lower end of the valve body 108. The valve body 108 and the end cover 110 may be arranged coaxially with the end piece 64 and abut against an upper end of the end piece 64.

The reversing valve 30 may further comprise a coil 112 and a magnetic yoke 114. The coil 112 may be inserted into the valve body 108 via a lower end of the valve body 108, and the end cover 110 may retain the coil 112 within the valve body 108. The magnetic yoke 114 may be disposed on a radially inner side of the coil 112 and arranged coaxially with the valve body 108. The magnetic yoke 114 may be fixedly connected to the valve body 108, and an upper end of the magnetic yoke 114 may be engaged with an upper end of the valve body 108.

The reversing valve 30 may further comprise an armature 116, a bushing 118, and a spring 120. The armature 116 may be disposed on the radially inner side of the coil 112 and arranged coaxially with the magnetic yoke 114. The bushing 118 may be disposed between the armature 116 and the coil 112 for guiding the armature 116 to move along the axial direction A. A lower end of the bushing 118 may extend downwards through the space between the end cover 110 and the armature 116 and abut against the end piece 64. The end piece 64, the armature 116, and the bushing 118 may jointly define a cavity 122, and the bushing 118 may separate the end cover 110 and the cavity 122. A gap 124 may be formed between the armature 116 and the bushing 118. A working medium in the cavity 122 can fill the area between the magnetic yoke 114 and the armature 116 via the gap 124 to balance the pressure at both ends of the armature 116. The spring 120 may be disposed between the magnetic yoke 114 and the armature 116 and configured to bias the armature 116 downwardly. When the coil 112 is in a powered state, the armature 116 may move along the axial direction A to an upper position and abut against the magnetic yoke 114. When the coil 112 is in an unpowered state, the armature 116 may move along the axial direction A to a lower position and be separated from the magnetic yoke 114.

The reversing valve 30 may further comprise a valve core 126 (an example of a pilot valve core). The valve core 126 may be arranged coaxially with the armature 116 and fixedly embedded into a lower end of the armature 116. When the coil 112 is in the powered state, the valve core 126 may be separated from the valve seat 79. When the coil 112 is in the unpowered state, the valve core 126 may abut against the valve seat 79.

The reversing valve 30 may further comprise a valve core 128 (an example of a pilot valve core) and a valve stem 130. The valve core 128 and the valve stem 130 may be arranged coaxially with the end piece 64. An upper end of the valve stem 130 may extend through the valve core 126 and be fixedly inserted into the armature 116. The valve core 128 may be disposed within the cavity 94 and fixedly supported at a lower end of the valve stem 130. The valve stem 130 may pass through the through-hole 80, and an annular space between an inner circumferential surface of the through-hole 80 and an outer circumferential surface of the valve stem 130 may be formed as a passage 132. When the coil 112 is in the powered state, the valve core 128 may abut against the valve seat 78 and form a sealing pair with the valve seat 78. When the coil 112 is in the unpowered state, the valve core 128 may be separated from the valve seat 78. The valve core 128 may comprise a frame 134 and a seal 136. The disk-shaped frame 134 may be arranged coaxially with the valve stem 130 and integrally formed with and joined to the lower end of the valve stem 130. The seal 136 may be supported onto the frame 134 for making contact with the valve seat 78.

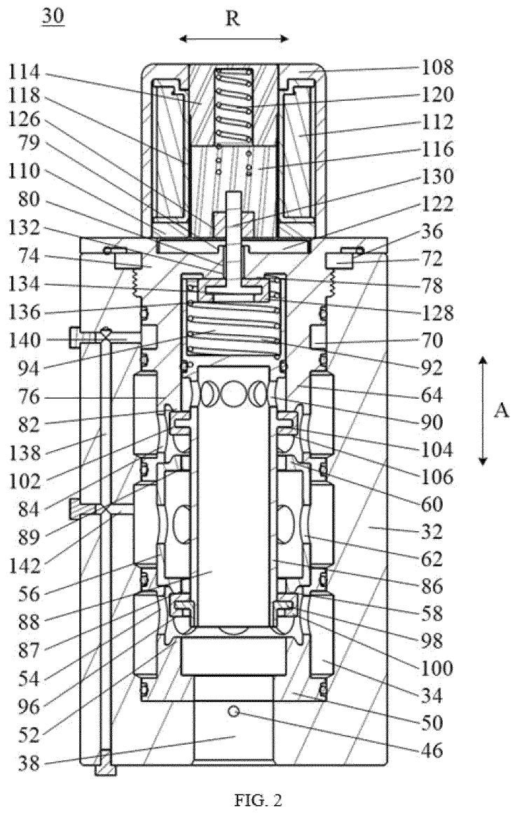

FIG. 2 is a further cross-sectional view of the reversing valve 30.

The valve body 32 may further comprise passages 138, 140, 142. The passage 138 may be disposed on the radially outer side of the valve cavity 34 and extend along the axial direction A. Passages 140, 142 may be disposed between the valve cavity 34 and the passage 138 and extend along the radial direction R. The passages 140, 142 may be arranged side-by-side along the axial direction A, and the passage 140 may be disposed on an upper side of the passage 142.

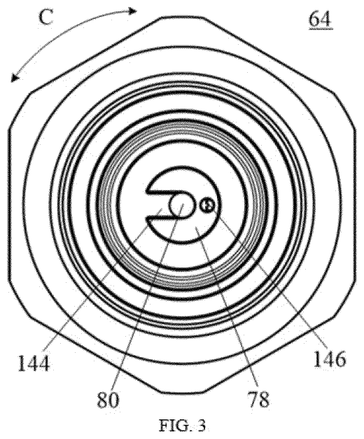

FIG. 3 is a schematic diagram of the end piece 64.

The valve seat 78 may be disposed at an edge portion of a lower end of the through-hole 80 and extend along a circumferential direction C of the end piece 64. The valve seat 78 may be discontinuous in the circumferential direction C, thereby forming a groove 144. The valve seat 78 may be provided with a port 146, and the groove 144 and the port 146 may be arranged side-by-side in the radial direction R (see FIG. 1). When the valve core 128 is separated from the valve seat 78, the cavity 94 may be in communication with the passage 66 via the port 146, and in direct communication with the passage 132. When the valve core 128 abuts against the valve seat 78, the valve core 128 may close the port 146, and the cavity 94 may remain in communication with the passage 132 via the groove 144.

Referring to FIGS. 1, 2, and 4, the reversing valve 30 may be switched between the first mode and the second mode.

Referring to FIGS. 1 and 2, in the first mode, the coil 112 may be in the powered state such that the armature 116 is in an upper position. The valve core 96 may be separated from the valve seat 52 and abut against the valve seat 58. The valve core 102 may be separated from the valve seat 60 and abut against the valve seat 82. The valve core 126 may be separated from the valve seat 79, and the valve core 128 may abut against the valve seat 78. The medium ends 38, 44 may be input ends for the working medium, and the medium ends 40, 42 may be output ends for the working medium. The medium end 38 may be in communication with the medium end 40 sequentially via a lower end opening of the valve sleeve 50, the valve seat 52 (the space between the valve seat 52 and the valve core 96, similar descriptions are omitted hereinafter), and the passage 54. The medium end 44 may be in communication with the medium end 42 sequentially via the passage 84, the valve seat 60, the passage 89, and the passage 62. The cavity 94 may be in communication with the medium end 42 sequentially via the groove 144, the passage 132, the cavity 122, the passage 68, the passage 70, the passage 140, the passage 138, and the passage 142 such that a portion of the working medium in the cavity 94 can be discharged from the reversing valve 30 via the medium end 42.

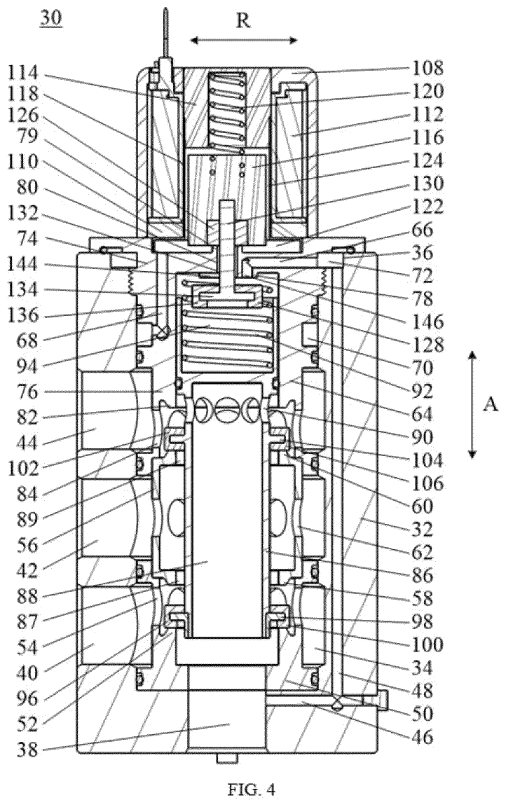

Referring to FIG. 4, in the second mode, the coil 112 may be in the unpowered state such that the armature 116 may be in a lower position. The valve core 96 may be separated from the valve seat 58 and abut against the valve seat 52. The valve core 102 may be separated from the valve seat 82 and abut against the valve seat 60. The valve core 126 may abut against the valve seat 79, and the valve core 128 may be separated from the valve seat 78. The medium ends 38, 40 may be input ends for the working medium, and the medium ends 42, 44 may be output ends for the working medium. The medium end 38 may be in communication with the medium end 44 sequentially via the lower end opening of the valve sleeve 50, the inner cavity 88, the passage 90, the valve seat 82, and the passage 84. The medium end 40 may be in communication with the medium end 42 sequentially via the passage 54, the passage 87, and the passage 62. The medium end 38 may be in communication with the cavity 94 sequentially via the passage 46, the passage 48, the passage 72, the passage 66, and the port 146 such that the working medium outside the reversing valve 30 may be supplied to the cavity 94 via the medium end 38.

In other words, the reversing valve 30 may be what is commonly referred to as a pilot-operated two-position four-way solenoid valve. The reversing valve 30 may comprise a main valve and a pilot valve that are coupled together. The valve seat 52, the valve seat 58, the valve seat 60, the valve seat 82, the valve core 96, and the valve core 102 may serve as at least a portion of the main valve. The valve seat 78, the valve seat 79, the valve core 126, and the valve core 128 may serve as at least a portion of the pilot valve. By switching the coil 112 between the powered state and the unpowered state, the pilot valve can adjust positions of the valve cores 96, 102, thereby changing the way in which the medium ends 38, 40, 42, 44 are in communication.

It is to be understood that examples of the first valve seat are not limited to the valve seat 58. For example, an example of the first valve seat may also be the valve seat 60, an example of the second valve seat may be adjusted to the valve seat 82 accordingly, and an example of the first valve core may be adjusted to the valve core 102 accordingly. In other embodiments, an example of the first valve seat may also be the valve seat 52 or the valve seat 82.

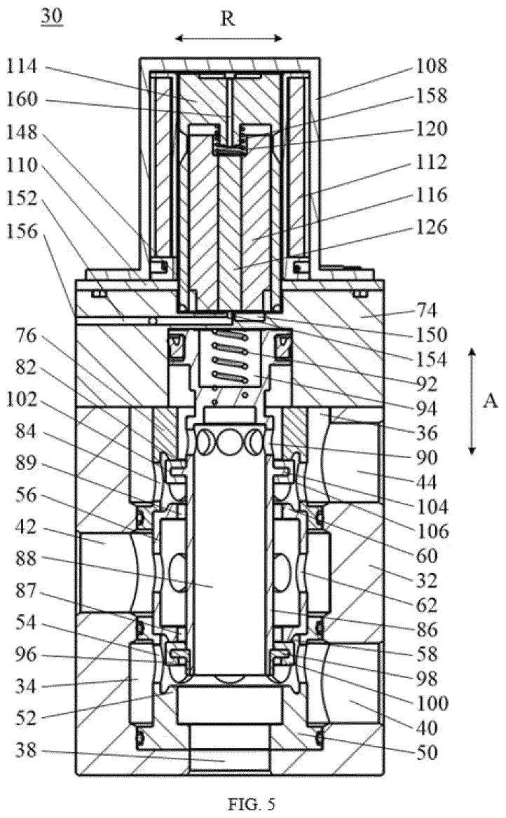

The structure of the reversing valve according to the second embodiment of the present application will be described below with reference to FIGS. 5 to 8. The second embodiment is a variation of the first embodiment. Features that are the same as or similar to those of the first embodiment are indicated by like reference numerals in the second embodiment, and will not be further elucidated herein.

FIG. 5 is a cross-sectional view of a reversing valve 30.

Unlike the first embodiment, the valve cover 74 and valve sleeve 76 of this embodiment are configured as two independent parts rather than being integrally formed. The valve cover 74 may cover the mounting end 36, and the lower end of the valve cover 74 may abut against the upper ends of the valve body 32 and the valve sleeve 76.

The valve cover 74 may comprise a valve seat 148, a groove 150, and a passage 152. The valve seat 148 and the groove 150 may be disposed at an upper end of the valve cover 74. The valve seat 148 may be provided with a port 154 thereon, and the port 154 may be disposed at a substantially central portion of the valve cover 74. The groove 150 may be disposed at an edge portion of the port 154 and extend along the circumferential direction. The passage 152 may be disposed above the cavity 94 and extend along the radial direction R. A radially outer end of the passage 152 may be formed as a medium end 156 on an outer circumferential surface of the valve cover 74.

The magnetic yoke 114 may comprise a valve seat 158 and a passage 160. The valve seat 158 may be disposed at a lower end of the magnetic yoke 114 and extend circumferentially along the entire circumference. The passage 160 may be disposed at a substantially central portion of the magnetic yoke 114 and extend through the magnetic yoke 114 along the axial direction A.

The armature 116 may be fixedly sleeved onto the valve core 126, and the valve core 126 may extend through the armature 116 in the axial direction A. When the coil 112 is in the powered state, the valve core 126 may abut against the valve seat 158 and be separated from the valve seat 148 such that a lower end of the passage 160 is closed by the valve core 126. When the coil 112 is in the unpowered state, the valve core 126 may abut against the valve seat 148 and be separated from the valve seat 158 such that the port 154 is closed by the valve core 126.

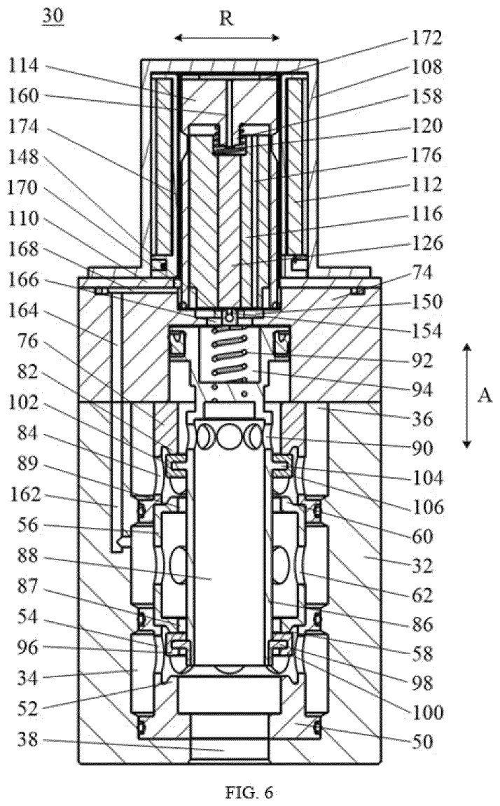

FIG. 6 is a further cross-sectional view of the reversing valve 30.

The valve body 32 may comprise a passage 162. The passage 162 may be disposed on the radially outer side of the valve cavity 34 and extend along the axial direction A.

The valve cover 74 may comprise a passage 164 and a plurality of passages 166. The passage 164 may be disposed on a radially outer side of the cavity 94 and extend along the axial direction A. The passage 166 may be disposed between the cavity 94 and the groove 150 and extend along the axial direction A. An upper end of the passage 166 may be disposed at a bottom surface of the groove 150. When the coil 112 is in the unpowered state, the upper end of the passage 166 is not closed by the valve core 126, so that the passage 166 can still be in communication with the passage 176 via the groove 150.

The end cover 110 may be capped onto the upper end of the valve cover 74, and together with the valve cover 74, define a passage 168. The passage 168 may be disposed on a radially outer side of the magnetic yoke 114 and extend along the radial direction R. The end cover 110 may be sleeved onto the magnetic yoke 114, and together with the magnetic yoke 114, define a passage 170. The passage 170 may extend along the axial direction A and extend through the end cover 110.

The magnetic yoke 114 and the valve body 108 may jointly define a passage 172. The passage 172 may be disposed above the magnetic yoke 114 and extend along the radial direction R. The magnetic yoke 114 and the coil 112 may jointly define a passage 174. The passage 174 may be disposed on the radially outer side of the magnetic yoke 114 and extend along the axial direction A.

The armature 116 may comprise a passage 176. The passage 176 may extend along the axial direction A and extend through the armature 116.

Referring to FIGS. 5 to 8, the reversing valve 30 may be switched between the first mode and the second mode.

Referring to FIGS. 5 and 6, in the first mode, the coil 112 may be in the unpowered state such that the armature 116 is in a lower position. The valve core 96 may be separated from the valve seat 52 and abut against the valve seat 58. The valve core 102 may be separated from the valve seat 60 and abut against the valve seat 82. The valve core 126 may abut against the valve seat 148 and be separated from the valve seat 158. The medium ends 38, 44, 156 may be input ends for the working medium, and the medium ends 40, 42 may be output ends for the working medium. The medium end 38 may be in communication with the medium end 40 sequentially via the lower end opening of the valve sleeve 50, the valve seat 52, and the passage 54. The medium end 44 may be in communication with the medium end 42 sequentially via the passage 84, the valve seat 60, the passage 89, and the passage 62. The cavity 94 may be in communication with the medium end 42 sequentially via the passage 166, the groove 150, the passage 176, the passage 160, the passage 172, the passage 174, the passage 170, the passage 168, the passage 164, and the passage 162 such that a portion of the working medium in the cavity 94 can be discharged from the reversing valve 30 via the medium end 42.

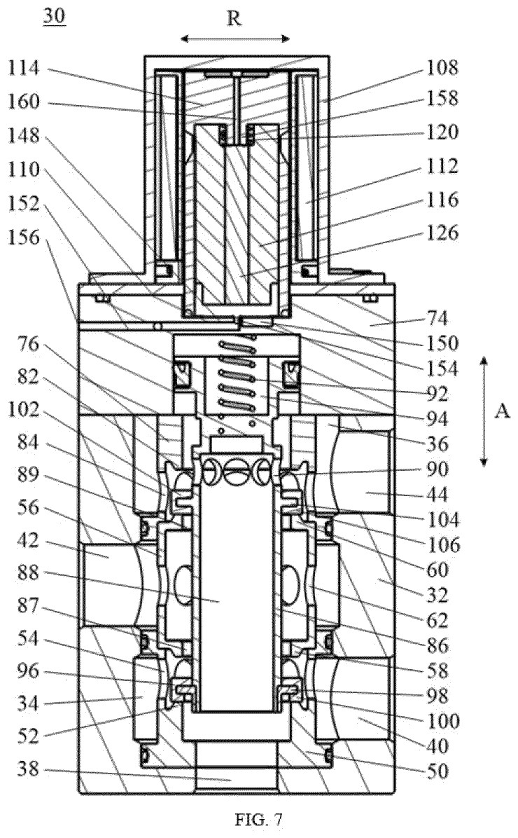

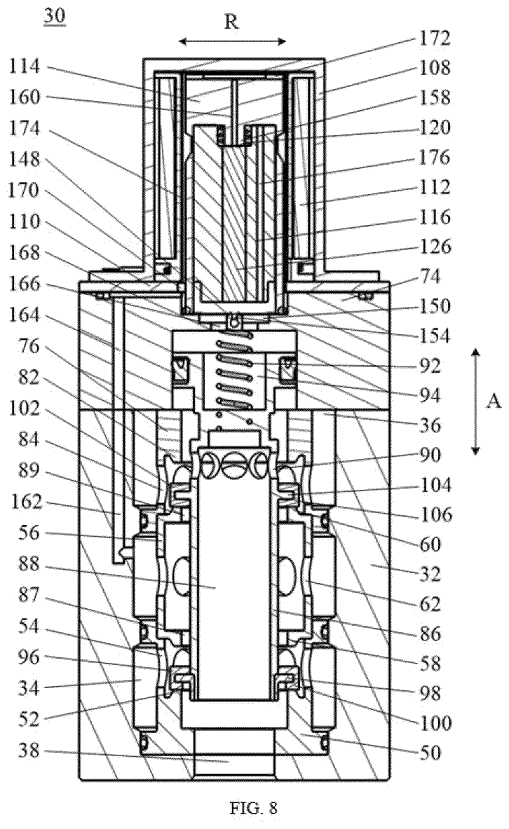

Referring to FIGS. 7 and 8, in the second mode, the coil 112 may be in the powered state such that the armature 116 may be in an upper position. The valve core 96 may be separated from the valve seat 58 and abut against the valve seat 52. The valve core 102 may be separated from the valve seat 82 and abut against the valve seat 60. The valve core 126 may be separated from the valve seat 148 and abut against the valve seat 158. The medium ends 38, 40, 156 may be input ends for the working medium, and the medium ends 42, 44 may be output ends for the working medium. The medium end 38 may be in communication with the medium end 44 sequentially via the lower end opening of the valve sleeve 50, the inner cavity 88, the passage 90, the valve seat 82, and the passage 84. The medium end 40 may be in communication with the medium end 42 sequentially via the passage 54, the passage 87, and the passage 62. The medium end 156 may be in communication with the cavity 94 sequentially via the passage 152, the port 154, the groove 150, and the passage 166 such that the working medium outside the reversing valve 30 may be supplied to the cavity 94 via the medium end 156.

The structure of the thermal management system according to a third embodiment of the present application will be described below.

The thermal management system may comprise a distributor and a reversing valve.

The distributor may comprise a plurality of interfaces and a distribution passage connected between these interfaces. External devices may be connected to the distribution passage via the interfaces such that a plurality of external devices may be integrated together by the distributor. For example, external devices may include, but are not limited to, valves, heat exchangers, gas-liquid separators, sensors, condensers, compressors, and the like.

In an example embodiment, the distributor may have a structure similar to the heat pump assembly mounting plate disclosed in Chinese utility model patent CN212765592U or the manifold disclosed in Chinese utility model patent CN217623047U. The contents of CN212765592U and CN217623047U are hereby incorporated by reference herein.

The reversing valve may be the reversing valve 30 of the first embodiment or the second embodiment. The reversing valve 30 may be integrated onto the distributor via the above-mentioned interfaces, and the valve body 32 may be integrally formed with at least a portion of the distributor. By switching the reversing valve 30 between the first mode and the second mode described above, the thermal management system can switch between what is commonly referred to as a Heat pump mode and an AC Cooling mode. Of course, the function of the reversing valve 30 is not limited to this.

It will be appreciated that by making the valve body 32 and the distributor integrally formed, the thermal management system can have fewer parts, so that the thermal management system can have a lighter weight and a compact structure. In addition, such a configuration can also eliminate the sealing measures between the valve body 32 and the interfaces, enabling the thermal management system to achieve a higher reliability.

It will be appreciated that by arranging the valve cores 126, 128 coaxially with the valve cores 96, 102, the reversing valve 30 can have a smaller radial dimension, making the reversing valve 30 less likely to interfere with other external devices mounted on the distributor, so that the thermal management system can have a compact layout.

It should be understood that the foregoing embodiments are exemplary only and are not intended to limit the present application. Those skilled in the art can make various variations and modifications to the foregoing embodiments according to the teachings of the present application without departing from the scope of the present application.

### LIST OF REFERENCE NUMERALS

30 reversing valve
32 valve body
34 valve cavity
36 mounting end
38 medium end
40 medium end
42 medium end
44 medium end
46 passage
48 passage
50 valve sleeve
52 valve seat
54 passage
56 valve sleeve
58 valve seat
60 valve seat
62 passage
64 end piece
66 passage
68 passage
70 passage
72 passage
74 valve cover
76 valve sleeve
78 valve seat
79 valve seat
80 through-hole
82 valve seat
84 passage
86 valve stem
87 passage
88 inner cavity
89 passage
90 passage
92 spring
94 cavity
96 valve core
98 frame
100 seal
102 valve core
104 frame
106 seal
108 valve body
110 end cover
112 coil
114 magnetic yoke
116 armature
118 bushing
120 spring
122 cavity
124 gap
126 valve core
128 valve core
130 valve stem
132 passage
134 frame
136 seal
138 passage
140 passage
142 passage
144 groove
146 port
148 valve seat
150 groove
152 passage
154 port
156 medium end
158 valve seat
160 passage
162 passage
164 passage
166 passage
168 passage
170 passage
172 passage
174 passage
176 passage
A axial direction
R radial direction
C circumferential direction

What is claimed is:

1. A reversing valve, comprising:
a valve body comprising a valve cavity and a mounting end in communication with the valve cavity;
a first valve seat and a second valve seat, the first valve seat and the second valve seat being arranged opposite one another within the valve cavity; and
a first valve core, the first valve core being movably disposed between the first valve seat and the second valve seat and configured to be separated from one of the first valve seat and the second valve seat when abutting against a remaining one of the first valve seat and the second valve seat, wherein
the first valve seat, the second valve seat, and the first valve core are configured to be inserted into the valve cavity via the same mounting end.

2. The reversing valve according to claim 1, wherein the reversing valve further comprises:
a third valve seat, the third valve seat and the first valve seat being arranged facing away from each other within the valve cavity; and
a second valve core fixedly connected to the first valve core within the valve cavity, and wherein:
the second valve core is configured to be separated from the third valve seat when the first valve core abuts against the first valve seat, and
and the second valve core is configured to abut against the third valve seat when the first valve core abuts against the second valve seat.

3. The reversing valve according to claim 2, wherein:
the reversing valve further comprises a fourth valve seat, and the third valve seat and the fourth valve seat are arranged opposite one another within the valve cavity,
the second valve core is movably disposed between the third valve seat and the fourth valve seat and is configured to be separated from one of the third valve seat and the fourth valve seat when abutting against the other of the third valve seat and the fourth valve seat, and
the second valve core is configured to abut against the fourth valve seat when the first valve core abuts against the first valve seat.

4. The reversing valve according to claim 2, wherein at least a portion of the first valve seat and at least a portion of the third valve seat are integrally formed.

5. The reversing valve according to claim 1, wherein the reversing valve further comprises a pilot valve for adjusting a position of the first valve core, the pilot valve comprising a pilot valve core arranged coaxially with the first valve core.

6. The reversing valve according to claim 1, wherein the first valve seat is constructed by a first valve sleeve, and the second valve seat is constructed by a second valve sleeve independent of the first valve sleeve.

7. The reversing valve according to claim 6, wherein the first valve sleeve and the second valve sleeve are cylindrical,
the first valve sleeve is provided with one or more first passages extending through a circumferential wall of the first valve sleeve along a radial direction of the first valve sleeve,
the second valve sleeve is provided with one or more second passages extending through a circumferential wall of the second valve sleeve along a radial direction of the second valve sleeve,
and the first passage is configured to be in communication with the second passage when the first valve core abuts against the second valve seat.

8. The reversing valve according to claim 7, wherein:
the reversing valve further comprises a valve stem, the valve stem being disposed on a radially inner side of the first valve sleeve and supporting the first valve core, the valve stem and the first valve seat jointly defining a third passage, and
the first passage is configured to be in communication with the second passage via the third passage when the first valve core abuts the second valve seat.

9. A thermal management system, comprising:
a distributor comprising a plurality of interfaces and a distribution passage connected between the plurality of interfaces; and
the reversing valve according to claim 1, the reversing valve being connected to the distribution passage via the interfaces.

10. The thermal management system according to claim 9, wherein at least a portion of the valve body is integrally formed with at least a portion of the distributor.

11. A reversing valve, comprising:
a valve body comprising a valve cavity and a mounting end in communication with the valve cavity;
a coil fixed to the valve body;
an armature disposed within the coil and configured to be moved via the coil along an axial direction;
a first valve seat and a second valve seat, the first valve seat and the second valve seat being arranged opposite one another within the valve cavity; and
a first valve core, the first valve core being movably disposed between the first valve seat and the second valve seat and configured to be separated from one of the first valve seat and the second valve set when abutting against a remaining one of the first valve seat and the second valve seat, wherein
the first valve seat, the second valve seat, and the first valve core are configured to be inserted into the valve cavity via the same mounting end.

12. The reversing valve according to claim 11, wherein:
in a first mode of the reversing valve, the armature is in an upper position and the first valve core is abutted with the first valve seat; and
in a second mode of the reversing valve, the armature is in a lower position and the first valve core is abutted with the second valve seat.

13. The reversing valve according to claim 11, wherein the coil is fixed to the mounting end of the valve body.

14. The reversing valve according to claim 11, further comprising:
a third valve seat disposed in the valve cavity; and
a second valve core movably disposed in the valve cavity, the second valve core configured to abut with the third valve seat.

15. The reversing valve according to claim 14, wherein the second valve core is fixedly connected to the first valve core.

16. The reversing valve according to claim 14, wherein the second valve seat is integral with the third valve seat.

17. The reversing valve according to claim 14, wherein:
in a first mode of the reversing valve, the armature is in an upper position and the first valve core is abutted with the first valve seat; and
in a second mode of the reversing valve, the armature is in a lower position and: i) the first valve core is abutted with the second valve seat, and ii) the second valve core is abutted with the third valve seat.

18. The reversing valve according to claim 17, further comprising a fourth valve seat configured to abut with the second valve core.

19. The reversing valve according to claim 18, wherein in the first mode of the reversing valve, the second valve core is abutted with the fourth valve seat and not the third valve seat.

20. The reversing valve according to claim 19, wherein the first valve seat, the second valve seat, the third valve seat, and the fourth valve seat are coaxial.
